(19) United States
(12) Patent Application Publication
(10) Pub. No.: US 2005/0029431 A1
(43) Pub. Date: Feb. 10, 2005

(54) Device for detecting passing of object and device for measuring velocity of passed object

(76) Inventor: Hiroshi Saegusa, Kanagawa Prefecture (JP)

Correspondence Address: Finnegan, Henderson, Farabow,;Garrett & Dunner, L.L.P., 1300 I Street, N.W., Washington, DC, 20005-3315, US

(21) Appl. No.: 10/812,911

(22) Filed: Mar. 31, 2004

(30) Foreign Application Priority Data
Apr. 1, 2003 (JP) 2003-097785

(51) Int. Cl. G01C 21/02

(52) U.S. Cl. 250/206.1

(57) ABSTRACT

A device for detecting a passing object of the present invention includes: a light source (18a); a light reflecting plate (14a) that reflects laser light (L) emitted from the light source (18a); and a light receiving sensor (20a) that receives laser light reflected by the light reflecting plate (14a). The light reflecting plate (14a) is reflecting plate that retroreflects incident light. In a device for measuring the velocity of a passed object of the present invention, two of the devices for detecting the passing object are disposed in different locations along a passing path through which the passing object passes. A passing velocity of the passed object is measured by using a time difference that is detected by the two devices for detecting the passing object. The device that detects the passing of the passing object has a simple configuration, and there are few restrictions on the locations at which the device may be disposed.

### BACKGROUND OF THE INVENTION

1. Field of the Invention

The present invention relates to a device for detecting a passing object that detects the passing of the passing object when the passing object traverses a light path between a light source and a light reflecting means such as a light reflecting plate. The present invention also relates to a device for measuring the velocity of a passed object, the device measuring the velocity of the object by using the device for detecting the passing object.

2. Description of the Related Art

The head speed of a golf club head when a golfer grips a golf club to make a golf swing can be found by lining up two devices for detecting a passing object, which detect the golf club head passing a predetermined position, along a path through which the golf club head passes, and measuring a difference between times at which the passing object is detected.

Reflection type photo interrupters and transmission type photo interrupters are available as the device for detecting a passing object.

By using a light receiving sensor, a reflection type photo interrupter detects reflected light that is emitted from a light source and is reflected by the surface of a passing object, thus detecting the passing of the object. In a transmission type photo interrupter, a light emitting diode (LED) light source that emits light is disposed on one side with respect to the passing path of the passing object, and a light receiving sensor that receives the emitted light is disposed on the other side with respect to the passing path of the passing object. The path through which the passing object travels is positioned to traverse a light path from the light source toward the light receiving sensor. Light is normally received by the light receiving sensor when there is no passing object present on the light path, and the light reception by the light receiving sensor is blocked when the passing object traverses the light path. These facts are utilized in detecting passing of the object.

With the reflection type photo interrupter, detection of the passing object can be accurately performed when the surface of the passing object has a fixed shape and the reflectivity of the surface is constant. Moreover, the device itself can be made small by integrating the light source and the light receiving sensor.

However, it is known that the detection accuracy changes according to the reflectivity of the surface of a passing object and according to the shape of the passing object when the reflectivity of the surface of the passing object is not constant, or when there are a variety of shapes of passing objects. It is therefore preferable to use a transmission type photo interrupter in which the passing object traverses the light path to block the light in order to detect the passing object with high accuracy.

For example, JP 10-206451 A can be given as a head speed measuring device for a golf club head using this transmission type photo interrupter.

This transmission type photo interrupter is configured so that a light receiving sensor continues receiving light when an object is not passing through. The light receiving sensor must be disposed as accurately positioned just on the optical axis of light that is emitted from a light source. In particular, it is necessary to make the light beam emitted from the light source narrow in width in order to precisely detect the passing of the object. Accordingly, the light receiving sensor must also be positioned accurately.

Therefore, the transmission type photo interrupter is configured with a light source and a light receiving sensor where the light receiving sensor is accurately positioned and fixed in advance on the optical axis of the light source.

There is the following problem, however, with the transmission type photo interrupter. One of the light source and the light receiving sensor is disposed at golfer's feet when measuring the head speed during a golf swing, and the other one of the light source and the light receiving sensor is disposed on an opposite side with respect to a passing path. Therefore, the transmission type photo interrupter may be annoyance and troublesome to the golfer. In addition, since the device for detecting a passing object must be disposed so that the passing path of the object traverses the light path between the light source and the light receiving sensor, there is a problem in that there are restrictions on the position of the device for detecting a passing object.

### SUMMARY OF THE INVENTION

In order to solve the problems described above, an object of the present invention is to provide a device for detecting a passing object, the device using the transmission type photo interrupter described above, having a configuration that is not troublesome, and with few restrictions on the position of the device. In addition, an object of the present invention is to provide a device for measuring the velocity of a passed object by using the device for detecting a passing object.

To achieve the above objects, the present invention provides a device for detecting a passing object as the passing object traverses a light path between a light source and a light reflecting means that reflects light emitted from the light source, the device including: the light source; the light reflecting means; and a light receiving sensor that receives light reflected by the light reflecting means, in which the light reflecting means has a function of retroreflecting incident light.

At that time, the device for detecting a passing object is preferably configured so that the light receiving sensor and the light source are disposed on a side opposite to the light reflecting means with respect to a passing path of the passing object.

In addition, it is preferable to dispose an optical member that transmits a portion of light and reflects a portion of light on a light path between the light source and the light reflecting means and to dispose the light receiving sensor to receive light that is reflected or transmitted by the optical member after being reflected by the light reflecting means.

Furthermore, the light source is preferably a laser light source.

In addition, the present invention provides a device for measuring the velocity of a passed object by using a time difference detected by two devices for detecting a passing object as the passing object traverses a light path between a light source and a light reflecting means that reflects light emitted from the light source, the two devices disposed along a passing path of the passing object, each of the devices including: the light source; the light reflecting means; a light receiving sensor that receives light reflected by the light reflecting means; and an optical member that transmits a portion of light and reflects a portion of light, in which, in each of the devices for detecting the passing object: the light source and the light receiving sensor are disposed on a side opposite to the light reflecting means with respect to the passing path of the passing object; a light path of light reflected by the light reflecting means and a light path of light incident on the light reflecting means are aligned each other; the optical member is disposed on the light path between the light source and the light reflecting means; and the light receiving sensor is disposed in a location so that the light receiving sensor receives light that is reflected by the light reflecting means and that is reflected or transmitted by the optical member.

At that time, the light reflecting means preferably has a function of retroreflecting incident light.

In addition, the light source is preferably a laser light source.

It should be noted that the passing object is, for example, a golf club head of a golf club that moves by being swung.

A light reflecting means such as a light reflecting plate has a function of retroreflection in the device of the present invention which detects a passing object when the passing object traverses a light path between a light source and the light reflecting means. The light source and a light receiving sensor can therefore be disposed together on one side of the passing path of the passing object. Moreover, it is unnecessary to adjust the direction toward which the light reflecting means such as a light reflecting plate faces. Therefore, the device configuration is not troublesome, and the degree of the set position of the device increases. Furthermore, highly accurate detection of a passing object can be performed by using a laser light source as the light source.

Further, in a device for measuring the velocity of a passed object that uses the device for detecting the passing object, the device configuration is not troublesome, and the degree of the set position of the device increases. In addition, the passing velocity of the object can be measured with high accuracy by using a laser light source as the light source.

### BRIEF DESCRIPTION OF THE DRAWINGS

In the accompanying drawings:

FIG. 1 is a schematic structural diagram of a head speed measuring device for a golf club head that uses a device for detecting a passing object of the present invention;

FIG. 2 is an explanatory diagram that explains a main part of a head speed measuring device of the present invention; and

FIG. 3 is a cross sectional view of an example of a retroreflective sheet that is used in a light reflecting means of the present invention.

### DETAILED DESCRIPTION OF THE PREFERRED EMBODIMENTS

A device for detecting a passing object, and a device for measuring the velocity of the passed object that uses the device for detecting the passing object, are explained below in detail with reference to preferred embodiments shown in the appended drawings.

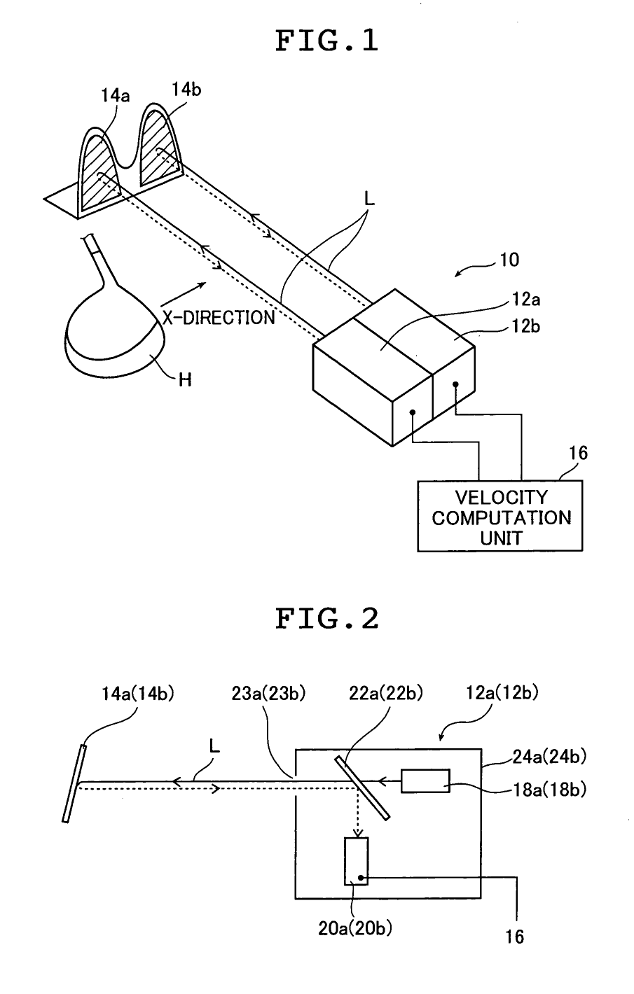

FIG. 1 is a schematic structural diagram of a head speed measuring device 10 for a golf club head according to one embodiment of the device for measuring the velocity of a passed object that uses the device for detecting the passing object of the present invention.

The head speed measuring device 10 measures the head speed of a golf club head as follows. Two devices for detecting a passing object are disposed in different locations along a passing path of a golf club head. Each of the devices for detecting the passing object detects the passing of the golf club head H during a golf swing.

As shown in FIG. 1, the head speed measuring device 10 includes sensor units 12a and 12b, light reflecting plates 14a and 14b, and a velocity computation unit 16.

It should be noted that one of the devices for detecting a passing object that detects the passing of the passing object is formed by the sensor unit 12a and the light reflecting plate 14a, and the other one of the devices for detecting a passing object that detects the passing of the passing object is formed by the sensor unit 12b and the light reflecting plate 14b.

The sensor units 12a and 12b have the identical structure, and are disposed in different locations along the passing path of the golf club head. Therefore the sensor unit 12a is explained hereinafter as a representative of the two sensor units 12a and 12b.

As shown in FIG. 2, the sensor unit 12a (12b) includes: a light source 18a (18b) that emits laser light L; a light receiving sensor 20a (20b) that is provided with a photoelectric device for receiving a portion of the laser light that is emitted from the light source 18a (18b) and is reflected by a light reflecting plate 14a (14b); and a half mirror 22a (22b) that reflects a portion of incident laser light and allows a portion of the incident laser light to pass through. A casing 24a (24b) on which an incident/emission hole 23a (23b) for the laser light is formed covers the light source 18a (18b), the light receiving sensor 20a (20b), and the half mirror 22a (22b).

The light source 18a (18b) is a known laser light source that emits laser light. For example, a semiconductor laser that emits laser light in a visible region may be used. It should be noted that, in the present invention, it is not always necessary for the light source to be a visible laser light source. A non-visible laser light source may also be used as the light source. In addition, the light source may also be an LED light source. However, it is preferable to use a laser light source in order to control the intensity of the light and the light beam to be narrow in width, and thus accurately detect the passing of the golf club head H.

The light receiving sensor 20a (20b) is a known sensor that uses a phototransistor in which a photodiode and a transistor are integrated. The light receiving sensor 20a (20b) receives the laser light when the golf club head H is not passing through, to output a constant value. When the laser light L from the light source 18a (18b) is interrupted by the golf club head H passing through, light reception is interrupted, and the light receiving sensor outputs a signal having a value that is lower than the constant value.

The half mirror 22a (22b) is a plate shape optical member through which a portion of the laser light L emitted from the light source 18a (18b) passes, and which reflects a portion of the laser light that is reflected by the light reflecting plate 14a (14b). In the present invention, a rectangular prism whose surfaces are coated with a metallic thin film such as a chromium film, or with a dielectric multi-layer film, may be used as a substitute for the half mirror. For example, a half prism having substantially an even ratio of its reflectivity and its transmittance may be used as the optical member.

The light reflecting plate 14a (14b) is a reflecting plate that reflects a portion of incident laser light in an incidence direction, and this is referred to as retroreflection. The light reflecting plate 14a (14b) is configured by applying a retroreflective sheet to the surface of a plate member.

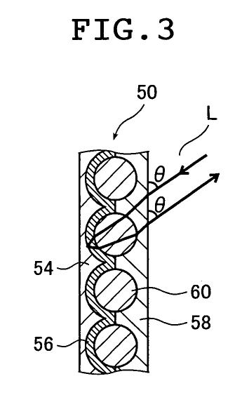

FIG. 3 is a cross sectional view of an example of a retroreflective sheet.

A retroreflective sheet 50 includes a binder layer 54, a reflective layer 56, a surface film layer 58, and a plurality of glass beads 60.

With this type of configuration, the laser light L that is incident on the retroreflective sheet 50 at an incidence angle θ undergoes refraction and reflection by the surface film layer 58, the glass bead layer 60, and the reflective layer 56, whereby a portion of the laser light L is directed from the surface film layer 58 at an angle of emission θ, that is, the direction in which the laser light is incident.

It should be noted that the retroreflective sheet of the light reflecting plate 14a (14b) is not limited to a retroreflective sheet having the cross sectional structure shown in FIG. 3. Other retroreflective sheets having known cross sectional structures may also be used. The retroreflective sheet may be one with which incident light is reflected in the incidence direction. A sheet that is disclosed in JP 61-13561 B can be given as an example. In addition, a known structure having a retroreflecting function such as a corner cube prism, corner cube reflector, or hollow retroreflector may also be used as a substitute for the retroreflective sheet. In particular, a corner cube prism has a relatively high reflectivity, and therefore the distance between the corner cube prism and the sensor unit 12a (12b) can be set longer. Further, other light sources such as LEDs each having a lower light intensity than that of the laser light source can be selected. The degree of the position of the sensor unit 12a (12b) and the degree of selection of the light source thus increase.

The velocity computation unit 16 is connected to output terminals of the sensor units 12a and 12b. The velocity computation unit 16 measures a time difference between the times at which the values of signals that are output from the sensor units 12a and 12b rapidly drop. The velocity computation unit 16 computes the head speed of the golf club head H by using the measurements and the known distance between the light paths of the sensor units 12a and 12b. The velocity computation unit 16 then displays the computed head speed on a monitor (not shown).

In this embodiment, the laser light L that is emitted from the light source 18a (18b) is transmitted by the half mirror 22a (22b) toward the light reflecting plate 14a (14b). The light receiving sensor 20a (20b) receives the laser light that is reflected by the half mirror 22a (22b). The following configuration may be used in the present invention. That is, the positions of the light source 18a (18b) and the light receiving sensor 20a (20b) are mutually exchanged. After the laser light that is emitted from the light source 18a (18b) is reflected by the half mirror 22a (22b), the laser light is directed toward the light reflecting plate 14a (14b). The laser light that is reflected by the light reflecting plate 14a (14b) and passes through the half mirror 22a (22b) is then received by the light receiving sensor.

With this type of head speed measuring device 10, when the golf head H is not passing through, a portion of the laser light that is emitted from the sensor unit 12a or 12b, passes through the half mirror 22a (22b), and in addition, is reflected by the light reflecting plate 14a (14b), reflected by the half mirror 22a (22b) and then received by the light receiving sensor 20a (20b), and a constant value is output.

On the other hand, the laser light L emitted from the sensor unit 12a or 12b is interrupted when the golf club head H moves in an X-direction as shown in FIG. 1 to traverse the light path of the laser light L. Light reception of the laser light L by the light receiving sensor 20a (20b) is interrupted. The signal output from the light receiving sensor 20a (20b) therefore falls and the value thereof drops suddenly.

The velocity computation unit 16 measures the time difference between the times at which the signals output from the sensor units 12a and 12b fall, and then computes the velocity of the passing golf club head H by using the known distance between the light paths of the laser light of the units 12a and 12b.

The light reflecting plate 14a (14b) retroreflects the incident laser light L at that time. A portion of the laser light L can therefore be reflected in the incidence direction, even if the incidence direction of the laser light L that is incident on the light reflecting plate 14a (14b) is not perpendicular to an incidence surface of the light reflecting plate 14a as shown in FIG. 2. The light paths of the incident light and the emitted light can thus be aligned each other. That is, it is not necessary to adjust the direction of reflection of the light reflecting plate 14a (14b) according to the location of the sensor unit 14a (14b) as long as the laser light L is incident on the light reflecting plate 14a (14b).

Further, the incidence angle of the light L that is emitted from the light source 18a (18b) and is incident on the half mirror 22a (22b) always coincides with the incidence angle of the laser light that is reflected by the light reflecting plate 14a (14b) and is incident on the half mirror 22a (22b). The laser light can therefore be received by the fixed light receiving sensor 20a (20b) even if the position adjustment of the light source 18a (18b), the light receiving sensor 20a (20b), and the half mirror 22a (22b) according to the direction of the light reflecting plate 14a (14b) is not performed.

Furthermore, the intensity of the laser light incident on the light receiving sensor 20a (20b) degreases owing to the transmittance, reflectivity, and absorptance of the half mirror 22a (22b) and the light reflecting plate 14a (14b). However, laser light having an enough intensity to be sensed by the light receiving sensor 20a (20b) can be received by the light receiving sensor 20a (20b) by employing high intensity laser light having narrow width of the light beam. Moreover, the light beam of the laser light within the light path can be narrow in width. The passing of the golf club head H can therefore be detected with high accuracy, and the head speed can be measured with high accuracy.

Still further, in the head speed measuring device 10, the light source 18a (18b) and the light receiving sensor 20a (20b) can be integrated and placed together in the opposite side of the light reflecting plate 14a (14b) with respect to the passing path of the golf club head H, and can be disposed as the sensor unit 12a (12b). In addition, it is not necessary to adjust the direction of the light reflecting plate 14a (14b) that is disposed on the opposite side of the sensor unit 12a (12b) with respect to the passing path of the golf club head H. The position at which the head speed measuring device 10 is disposed can therefore be set with few restrictions. The device configuration becomes extremely simple, and the position of the device can be set not to annoy a golfer during a golf swing.

The device for detecting a passing object of the present invention has been explained by taking as an example device that measures the head speed of a golf club head by detecting passing of the golf club head. However, the device for detecting the passing object of the present invention is not limited to one for detecting the passing of the golf club head. For example, the passing body may be a golf ball immediately after being hit. The flight direction of the golf ball can easily be measured by disposing a plurality of the devices for detecting the passing object of the present invention along the flight path of the golf ball. Further, the device for detecting the passing object can be applied to passing objects such as a ball in flight and a swung bat of the baseball. Furthermore, the device can be applied to all moving objects such as a bicycle and a automobile.

The device for detecting the passing object and the device for measuring the velocity of the passed object of the present invention have been explained in detail above. However, the present invention is not limited to the embodiments described above. A variety of improvements and changes may also be made within a range that does not deviate from the gist of the present invention.

1. A device for detecting a passing object as the passing object traverses a light path between a light source and a light reflecting means that reflects light emitted from the light source, the device comprising:
said light source;
said light reflecting means; and
a light receiving sensor that receives light reflected by the light reflecting means,
wherein said light reflecting means has a function of retroreflecting incident light.

2. The device for detecting a passing object according to claim 1, wherein said light receiving sensor and said light source are disposed on a side opposite to the light reflecting means with respect to a passing path of the passing object.

3. The device for detecting a passing object according to claim 2, further comprising an optical member that transmits a portion of light and reflects a portion of light, said optical member being disposed on a light path between said light source and said light reflecting means,
wherein said light receiving sensor is disposed to receive light that is reflected or transmitted by said optical member after being reflected by said light reflecting means.

4. The device for detecting a passing object according to claim 1, wherein the light source is a laser light source.

5. A device for measuring a velocity of a passed object by using a time difference detected by two devices for detecting a passing object as the passing object traverses a light path between a light source and a light reflecting means that reflects light emitted from the light source, said two devices being disposed along a passing path of the passing object, each of said devices comprising:
said light source;
said light reflecting means;
a light receiving sensor that receives light reflected by said light reflecting means; and
an optical member that transmits a portion of light and reflects a portion of light,
wherein, in each of said devices for detecting the passing object:
said light source and said light receiving sensor are disposed on a side opposite to the light reflecting means with respect to the passing path of the passing object;
a light path of light reflected by said light reflecting means and a light path of light incident on said light reflecting means are aligned each other;
said optical member is disposed on the light path between said light source and said light reflecting means; and
said light receiving sensor is disposed in a location so that said light receiving sensor receives light that is reflected by said light reflecting means and that is reflected or transmitted by said optical member.

6. The device for measuring a velocity of a passed object according to claim 5, wherein said light reflecting means has a function of retroreflecting incident light.

7. The device for measuring a velocity of a passed object according to claim 5, wherein said light source comprises a laser light source.

8. The device for measuring a velocity of a passed object according to claim 5, wherein the passed object is a golf club head of a golf club that moves by being swung.
